(19) United States
(12) Patent Application Publication
(10) Pub. No.: US 2018/0222039 A1
(43) Pub. Date: Aug. 9, 2018

(54) CARRIAGE SUPPORT UNIT AND ROBOT CARRIAGE

(71) Applicants: Gi Sang LEE, Ulsan (KR); BIZNC CO., LTD., Ulsan (KR)

(72) Inventor: Gi Sang LEE, Ulsan (KR)

(21) Appl. No.: 15/789,398

(22) Filed: Oct. 20, 2017

(30) Foreign Application Priority Data
Feb. 8, 2017 (KR) 10-2017-0017558

(51) Int. Cl. B25J 5/02; F16H 19/04

(52) U.S. Cl. CPC B25J 5/02; F16H 55/10; F16H 19/04

(57) ABSTRACT

A carriage support unit and a robot carriage are provided. The carriage support unit includes a base unit provided in a way that a robot and the like can be installed thereon; a linear motion guide unit provided in the one side of the base unit, enabling linear movement of the base unit; a mounting unit disposed in the upper surface of the base unit; a driving means installed in the mounting unit; a pinion gear unit coupled to the rotating shaft of the driving means; a rack gear unit engaged with the pinion gear unit; and a sliding means enabling the mounting unit being slided towards one direction so as to adjust the degree of engagement of the pinion gear unit with the rack gear portion.

### CROSS-REFERENCE TO RELATED PATENT APPLICATION

This U.S. non-provisional patent application claims priority under 35 U.S.C. § 119 of Korean Patent Application No. 10-2017-0017558 filed on Feb. 8, 2017 in the Korean Patent Office, the entire contents of which are hereby incorporated by reference.

### BACKGROUND

### 1. Technical Field

The present invention relates to a carriage support unit and a robot carriage having a long maintenance period due to the high speed and a non-lubricating feature, capable of minimizing the production downtime and saving the labor, and, during assembling of the pinion gear unit, the degree of engagement of the pinion gear unit with the rack gear portion can be adjusted properly, thereby increasing convenience of assembling.

### 2. Description of Related Art

Generally, a car body assembly process is a process of sequential welding and assembling of various press-formed panels, for example, a floor body, a side body, a roof, a cowl, a package tray, and the like. Such assembly process requires the highest precision in the vehicle assembly process. Accordingly, assembly process automation using robot technology has been applied so as to enhance the assembly accuracy, and at the same time, increase the productivity.

Among the automation equipment using robot technology, a robot carriage which is transport system for moving robots is suggested in Korea Patent No. 10-1118506 ‘Carriage support roller unit and robot transport carriage comprising the same.’

According to above mentioned official gazette, a robot transport carriage comprises: a pair of rails disposed in parallel; a pair of carriage support roller units movably coupled along each of the rails; a base installed in a pair of carriage support rollers; a rack gear installed in at least one of the facing surfaces of the pair of rails; a driving means installed in the base; a pinion gear coupled to the rotating shaft of the driving means, engaged with the rack gear; and a connecting bar whose both ends are connected to the pair of carriage support roller units.

However, the robot transport carriage of the prior art has a problem as follows.

Since the support rollers are used, the high viscosity lubrication oil must be inserted periodically, and therefore, there is a problem in that solidification is accelerated due to the increase in the viscosity of the dust, thereby requiring periodic replacement of the bearings. Due to this, the periodic management cost is increased.

In addition, there is a disadvantage in that only the skilled workers can carry out the assembly work due to the characteristics of roller assembling process, and there is no assembly error absorption function.

### SUMMARY

### 1. Technical Problem

An objective of the present invention devised for solving the above described problems is to provide a carriage support unit and a robot carriage: capable of increasing the cleanness of the factory since lubrication oil is not needed; having an assembly error absorption function; enabling anyone without a skill to work for the assembly; having a long maintenance period due to the high speed and a non-lubricating feature; and capable of not only minimizing the production downtime and saving the labor but also increasing convenience of assembling during assembling of the pinion gear unit because the degree of engagement of the pinion gear unit with the rack gear portion can be adjusted properly.

### 2. Solution to Problem

A carriage support unit according to the present invention comprises: a base unit provided in a way that robot and the like can be installed thereon; a linear motion guide unit provided in the one side of the base unit, enabling linear movement of the base unit; a mounting unit disposed in the upper surface of the base unit; a driving means installed in the mounting unit; a pinion gear unit coupled to the rotating shaft of the driving means; a rack gear portion engaged with the pinion gear unit; and a sliding means enabling the mounting unit being slided towards one direction so as to adjust the degree of engagement of the pinion gear unit with the rack gear portion.

In the present invention, it is characterized in that the sliding means comprises: a sliding block provided in the one side of the mounting unit, formed with a coupling hole formed with a first threaded portion; and a shaft whose one end is supported at the base unit, and the other end of the shaft is formed with a second threaded portion which is to be engaged with the first threaded portion.

In the present invention, it is characterized in that a guide means is further included for guiding the mounting unit when the mounting unit is slided by the sliding means, wherein the guiding means comprises: a guide slot formed in the lower surface of the mounting unit long in length towards the direction of movement of the mounting unit; and a guide pin whose one end is installed in the base unit and the other end of guide pin is inserted into the guide slot.

In the present invention, it is characterized in that the pinion gear unit comprises: a first disc block; a second disc block disposed in parallel with and spaced apart from the first disc block; and a plurality of gear teeth whose one end is connected to the one surface of the first disc block, the other end of the plurality of gear teeth is connected to the one surface of the second disc block, formed in the shape of a cylinder, disposed spaced apart from each other along the circumference of the first disc block and the second disc block, wherein the gear teeth are engaged with the rack gear portion.

Meanwhile, it is characterized in that a robot carriage of the present invention comprises: a pair of frame members disposed in parallel with each other; and a carriage support unit provided in a way that movable along the frame members, provided in a way that robot and the like can be installed thereon, wherein the carriage support unit comprises: a base unit disposed traversing the upper surface of the pair of frame members, provided in a way that the robot can be installed thereon; a linear motion guide unit provided in the both sides of the base unit and in each of the pair of frame members, enabling the base unit to be moved linearly along the frame members; a mounting unit disposed in the upper surface of the base unit; a driving means installed in the mounting unit; a pinion gear unit coupled to the rotating shaft of the driving means; a rack gear portion provided in any one frame member of the pair of frame members, engaged with the pinion gear unit; and a sliding means enabling the mounting unit being slided towards one direction so as to adjust the degree of engagement of the pinion gear unit with the rack gear portion.

### 3. Advantageous Effects

According to a carriage support unit and a robot carriage, there are effects as follows.

First, lubrication oil doesn't have to be used by using the linear motion guide unit in a way that the base unit can be moved linearly therefore the cleanness of the factory can be increased so that the environmental pollution can be prevented.

Second, due to a high speed and a non-lubricating feature, the maintenance period becomes longer so that the maintenance cost can be reduced, the production downtime can be minimized, and the saving of labor becomes possible.

Third, there is an advantage that the assembly work can be carried out by anyone without skill by having an assembly error absorption function.

Fourth, a good environment can be provided for the workers through low noise implementation.

Fifth, a compact system can be realized and a compact and weight reduction design can be implemented by adopting lightweight modules.

Sixth, the productivity can be enhanced through performing a high speed/high precision operation, and the quality of product can be enhanced.

Seventh, by providing a sliding means enabling the mounting unit being slided towards one direction, there is an effect that convenience of assembling is increased during assembling of the pinion gear unit since the degree of engagement of the pinion gear unit with the rack gear portion can be adjusted properly.

Eighth, since a guide means is provided for guiding the mounting unit when the mounting unit is slided by the sliding means, the guide means plays the role of simultaneously holding the moving position and the angle when the mounting unit is slided so that the pinion gear unit can be assembled to the rack gear portion with an accurate position and an angle by the guide means.

### BRIEF DESCRIPTION OF DRAWINGS

FIG. 1 is a prospective view illustrating a robot carriage according to the preferred exemplary embodiment of the present invention.

FIG. 2 is a view illustrating the cross-section of a portion wherein the carriage support unit in FIG. 1 is located.

FIG. 3 is an enlarged view illustrating a portion of FIG. 2.

FIG. 4 is an enlarged view illustrating the driving means and the sliding means in FIG. 1.

FIG. 5 is a view illustrating the area wherein the rack gear portion and the pinion gear unit are engaged in FIG. 1.

FIG. 6 is a view illustrating the guide means in FIG. 1.

### DESCRIPTION OF SYMBOLS

100: frame member
200: base unit
300: linear motion guide unit
310: linear motion block
350: linear motion rail
400: mounting unit
500: driving means
600: pinion gear unit
610: first disc block
630: second disc block
650: gear teeth
700: rack gear portion
800: sliding means
810: sliding block
850: shaft
900: guide means
910: guide slot
930: guide pin

### DETAILED DESCRIPTION OF EMBODIMENTS

Hereinafter, a preferred exemplary embodiment of the present invention will be described in detail with reference to the accompanying drawings. Prior to this, understood that the terms and words used in the specification and claims should not to be construed as limited to general and dictionary meanings, but should be interpreted as meanings and concepts corresponding to technical aspects of the present invention on the basis of the principle that the inventor may appropriately define the terms in order to describe his or her invention in a best way.

Thus, the exemplary embodiments described herein and the configuration illustrated in the drawings are nothing but the most preferred embodiment of the present invention, and since they are not representing all of the technical spirits of the present invention, it should be understood that various equivalents and modifications that may replace those (preferred embodiments) could be existing at the time of this application.

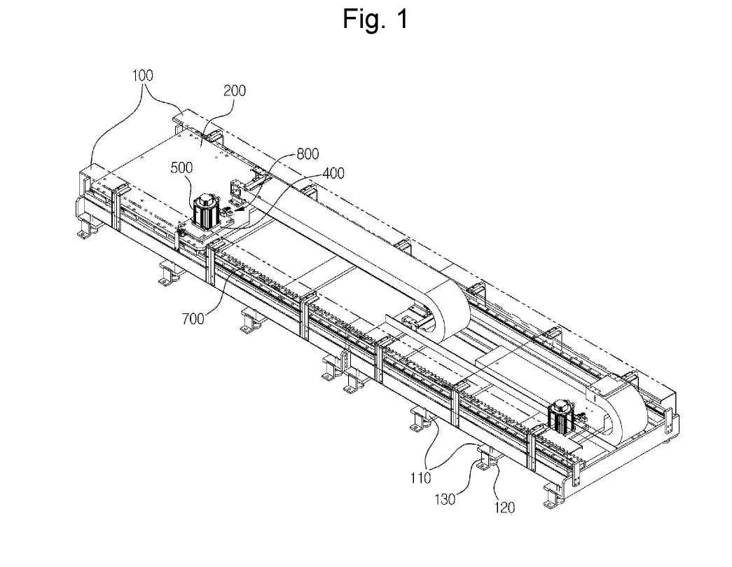

A robot carriage according to the preferred exemplary embodiment of the present invention, as illustrated in FIG. 1, comprises a pair of frame members 100 and a carriage support unit including components 200, 400, 500, 700, and 800.

First, a pair of frame members 100, as illustrated in FIG. 1, is disposed in parallel and spaced apart from each other with a separation distance, and it is preferred to be disposed long in length along one direction for a distance that a robot installed in the upper surface of the base unit 200 of the carriage support unit should be moved.

The lower surface of the pair of frame members 100 is preferred to be connected to each other through the frame base 110. In this exemplary embodiment, the frame base 110 connects a pair of the frame members 100 to each other while it is disposed in the lower surface of the pair of frame members 100 and traverses the frame members 100, and a plurality of frame bases 110 is provided space apart from each other between the pair of frame members 100.

Such each of the frame bases 110 is installed on the ground surface by the leveling bolt 120, and the height of the frame base 110 disposed from the ground surface can be appropriately adjusted by adjusting the leveling bolt 120.

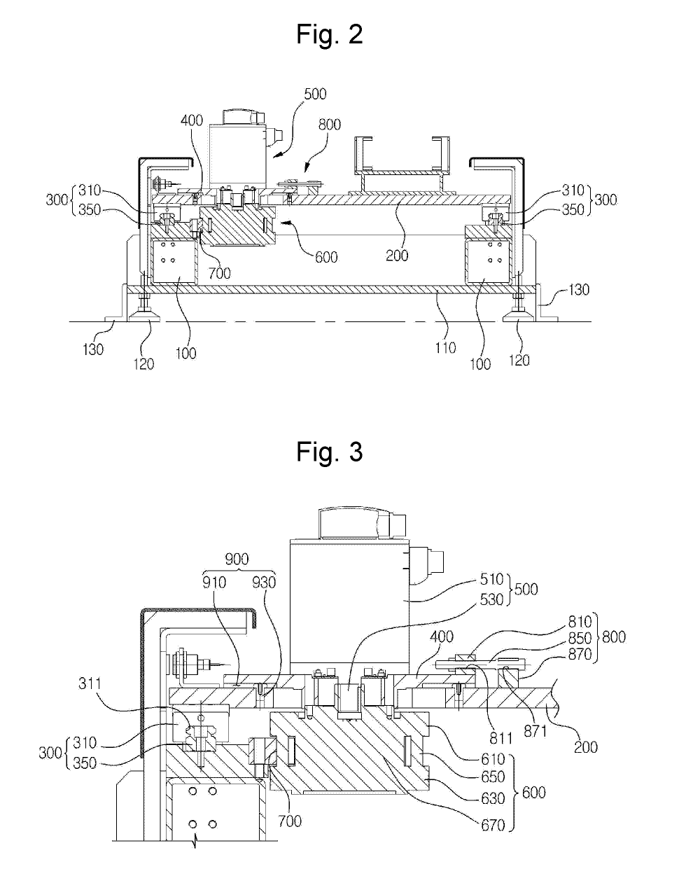

A pair of plate 130 in the shape of a letter ‘L’ may be installed at the both sides of each of the frame base 110 as illustrated in FIG. 2. That is, the plate 130 in the shape of a letter ‘L’ is installed in a way that the side surface of the frame base 110 and the ground surface are connected to each other, enables the frame base 110 to be stably supported at the ground surface.

Next, the carriage support unit including components 200, 400, 500, 700, and 800 is movably provided along the pair of frame members 100, and provided in a way that robot and the like can be installed on the upper surface thereof.

Such a carriage support unit, as illustrated in FIG. 2, preferably comprises: a base unit 200; a linear motion guide unit 300; a mounting unit 400; a pinion gear unit 600; a rack gear portion 700; a sliding means 800; and a guide means 900.

The base unit 200, as illustrated in FIGS. 1 and 2, is disposed traversing the upper surface of a pair of frame members 100, and provided to be flat in a way that robot and the like for assembly process of vehicle components can be installed on the upper surface thereof.

In the present exemplary embodiment, the base unit 200 is formed in the shape of a rectangular plate, and disposed traversing the upper surface of a pair of frame members 100, and supported at the upper surface of the frame members 100 by a pair of linear motion guide units 300 which will be described herein below.

The linear motion guide units 300, as illustrated in FIG. 2, are provided in the both sides of the base unit 200 and a pair of frame members 100 respectively, thereby enabling the base unit 200 to be linearly moved along the pair of frame members 100.

It is preferred that such a linear motion guide unit 300 comprises a linear motion block 310 and a linear motion rail 350.

The upper surface of the linear motion block 310 is fixed to the lower surface of the base unit 200. In the present exemplary embodiment, a pair of linear motion blocks 310 is installed at the both sides of the lower surface of the base unit 200 respectively. In the lower surface of such linear motion block 310, as illustrated in FIG. 3, a rail insertion slot 311 is formed.

The upper surface of the linear motion rail 350 is inserted into a rail insertion slot 311 of the linear motion block 310, and the lower end of the linear motion rail 350 is fixed to the frame member 100. In the present exemplary embodiment, the linear motion rail 350 is respectively installed in each of the pair of the frame members 100.

As configured as described above, the linear motion block 310 can possibly being moved along the linear motion rail 350 so that the base unit 200 can be linearly moved along the frame member 100.

The mounting unit 400, as illustrated in FIGS. 1 and 2, is disposed at the upper surface of the base unit 200, and especially, disposed at the side close to the frame member 100 wherein a rack gear portion 700 which will be described later is provided.

In the present exemplary embodiment, the mounting unit 400 is formed in the shape of a rectangular plate with an area smaller than that of the base unit 200. In addition, the mounting unit 400 is provided at the side close to the left side frame member 100 in FIG. 2, which is the side close to the frame member 100 wherein the rack gear portion 700 is provided, and especially, it can be provided at the side close to the corner of the base unit 200 as shown in FIG. 1.

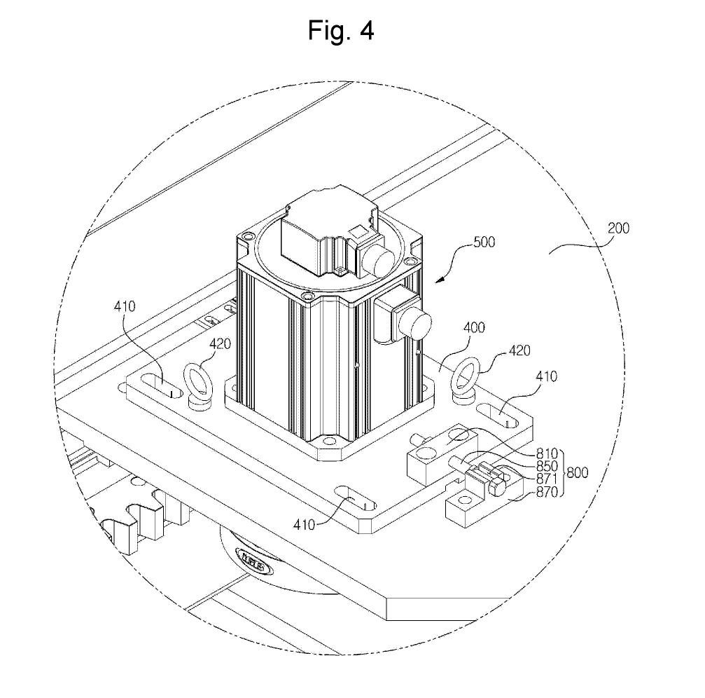

In such mounting unit 400, as illustrated in FIG. 4, a plurality of coupling holes 410 may be formed wherein a coupling means for fixing it to the upper surface of the base unit 200. In the present exemplary embodiment, the coupling holes 410 are respectively formed at the four corner sides of the mounting unit 400 and are formed in the shape of an elongated hole long in length along the one direction. Such coupling holes 410 in the shape of an elongated hole is formed long in length towards the moving direction of the mounting unit 400 when the mounting unit 400 is moved towards one direction by a sliding means 800 which will be described later herein below.

In addition, in the upper surface of the mounting unit 400, eye bolts 420 are installed to facilitate the lifting or moving of the mounting unit 400 as necessary.

In the mounting unit 400 configured as described above, as illustrated in FIGS. 2 and 3, a driving means 500 such as motor and the like is installed.

In the present exemplary embodiment, the driving means 500 is illustrated in FIG. 3, wherein a motor main body 510 is vertically disposed on the upper surface of the mounting unit 400, and a rotating shaft 500 is penetrating the mounting unit 400 from the upper surface towards the lower surface. That is, the end of a rotating shaft 530 is protruded towards the lower surface of the mounting unit 400.

As illustrated in FIGS. 2 and 3, the pinion gear unit 600 is coupled to the rotating shaft 530 of the driving means 500. That is, the pinion gear unit 600 is coupled to the rotating shaft 530 protruded towards the lower surface of the mounting unit 400.

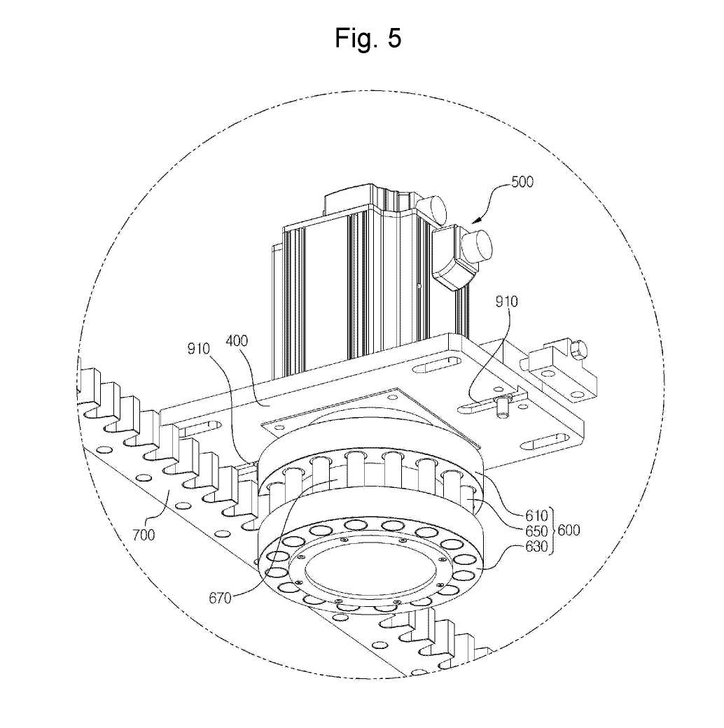

As illustrated in FIGS. 3 and 5, the pinion gear unit 600, which is coupled to the rotating shaft 530 of the driving means 500 in this way, preferably comprises a first disk block 610, a second disc block 630, and a plurality of gear teeth 650.

It is preferred that the first disk block 610 and the second disc block 630 have the same size and shape, and the first disk block 610 and the second disc block 630 are disposed in parallel and spaced apart from each other.

The gear teeth 650 connects the first disk block 610 and the second disc block 630 disposed spaced apart from each other, especially in the present exemplary embodiment, the gear teeth 650 is configured to be in the shape of a cylinder so that the one end of the gear teeth 650 is connected to the lower surface of the first disc block 610 and the other end of the gear teeth 650 is connected to the upper surface of the second disc block 630.

Such gear teeth 650 of cylindrical shape are configured in multiple numbers and disposed spaced apart from each other along the circumferences of the first disk block 610 and the second disc block 630.

Further, the pinion gear unit 600 may further comprise a connecting unit 670 connecting the first disk block 610 and the second disc block 630 in order to increase the strength. That is, it can be provided in a way that the connecting unit 670 may be disposed inner side of the plurality of gear teeth 650 provided along the circumferences of the first disk block 610 and the second disc block 630.

As illustrated in FIG. 3, the first disk block 610, the second disc block 630, the connecting unit 670, and the plurality of gear teeth 650 may be formed into a single member according to the exemplary embodiment.

As illustrated in FIGS. 2 and 3, the rack gear portion 700 is provided in any one frame member 100 of the pair of frame members 100, and engaged with the pinion gear unit 600.

In FIGS. 2 and 3, the rack gear portion 700 is provided along the inner side of the upper surface of the frame member 100 disposed at the left side, and thus the mounting unit 400 wherein the driving means 500 and the pinion gear unit 600 are installed is also provided at the left side of the base unit 200.

In this present exemplary embodiment, the shape of a cycloidal tooth is applied to the shape of the teeth of the rack gear portion 700 so as to have a low tooth surface pressure, and the wearing out occurs consistently due to a constant slip rate. In addition, in the present exemplary embodiment, chromium-molybdenum alloy steel is applied to the rack gear portion 700.

The gear teeth 650 of the pinion gear unit 600 are engaged with such rack gear portion 700.

At this time, since the rack gear portion 700 has the shape of a cycloidal tooth it can have a high teeth contact ratio when it is engaged with the gear teeth 650 of the pinion gear unit 600.

As illustrated in FIGS. 3 and 4, the sliding member 800 is a member that enables the mounting unit 400 to be slided from the base unit 200 towards one direction so as to adjust the degree of engagement of the pinion gear unit 600 with the rack gear portion 700.

It is preferred that such sliding means 800 comprises a sliding block 810 and a shaft 850.

The sliding block 810 is provided in one side of the upper surface of the mounting unit 400, and a coupling hole 811 is formed in one side of the sliding block 810. A first threaded portion is formed in the surface of the inner wall of the coupling hole 811.

The one end of the shaft 850 is supported at the base unit 200, and in the other end thereof, a second threaded portion to be engaged with a first threaded portion is formed.

The structure wherein the one end of the shaft 850 is supported at the base unit 200 will be described as follows. As illustrated in FIG. 4, a supporting bracket 870 is supported at the upper surface of the base unit 200, and a supporting slot 871 whose upper side is open is formed in the supporting bracket 870. When the one end of the shaft 850 is inserted into this supporting slot 871, the one end of the shaft 850 is supported at the base unit 200 thereby.

In the sliding means 800 configured as described above, when the shaft 850 is rotated the mounting unit 400 is slided from the base unit 200 towards one direction due to the rotation of the shaft 850 because the second threaded portion formed in the shaft 850 is engaged with the first threaded portion formed in the coupling hole 811 of the sliding block 810. Thus, since the pinion gear unit 600 connected to the driving means 500 installed in the mounting unit 400 is slided towards one direction, the degree of engagement of the pinion gear unit 600 with the rack gear portion 700 can be adjusted thereby.

As described above, when the mounting unit 400 is slided by the sliding means 800, a guide means 900 guides the mounting unit 400. That is, the guide means 900 plays the role of holding the position and angle of the movement of the mounting unit.

It is preferred that such guide means 900 comprises a pair of guide slots 910 and a pair of guide pins 930 as illustrated in FIG. 3.

The guide slots 910 are formed in the lower surface of the mounting unit 400 long in length towards the direction of movement of the mounting unit 400 as illustrated in FIGS. 3 and 5. In the present exemplary embodiment, the guide slots 910 are respectively formed in the center of the both sides of the lower surface of the mounting unit 400.

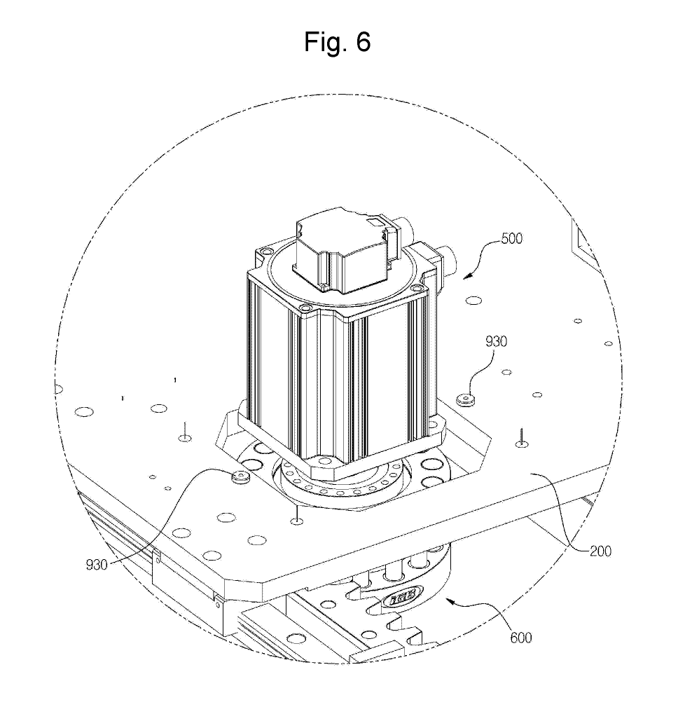

As illustrated in FIGS. 3 and 6, the one end of the guide pin 930 is installed on the upper surface of the base unit 200, and the other end of the guide pin 930 is inserted into the guide slot 910.

Thus, when the mounting unit 400 is slided from the base unit 200 towards one direction by the sliding means 800, since the guide pin 930 is inserted into the guide slot 910, the guide slot 910 of the mounting unit 400 is supported by the guide pin 930 so that it is accurately guided and slided towards one direction.

It is preferred that the guide means 900 configured as described above are respectively provided in the front side and the rear side on the line where the pinion gear unit 600 is assembled as illustrated in FIGS. 3 and 5. The reason is that the disposing of the guide means 900 respectively in the front side and the rear side of where the pinion gear unit 600 is to be assembled is desirable in the aspect of assembling the pinion gear unit 600 more precisely.

Further, it is preferred that the guide means 900 is provided on the center line of the pinion gear unit 600. That is, the disposing of the guide means 900 in the center of the location where the pinion gear unit 600 is to be assembled is desirable in the aspect of guiding towards the precise location and angle wherein the pinion gear unit 600 is to be assembled.

In this way, the pinion gear unit 600 can be assembled to the rack gear portion 700 by the guide means 900 with an accurate position and angle.

According to a carriage support unit and a robot carriage of the present invention, there are effects as follows.

By using a linear motion guide unit 300 in a way that the linear movement of the base unit 200 becomes possible, there are advantages in that: the cleanness of the factory can be increased since lubrication oil is not needed: the assembly error absorption function is possessed; and the assembly work can be carried out by anyone without skill.

Thus, the maintenance period becomes long due to high speed and a non-lubricating feature, and the production downtime can be minimized, and the saving of labor becomes possible.

Further, by providing a sliding means 800 enabling the mounting unit 400 being slided towards one direction, there is an effect that convenience of assembling is increased during assembling of the pinion gear unit 600 since the degree of engagement of the pinion gear unit 600 with the rack gear portion 700 can be adjusted properly.

In addition, since a guide means 900 is provided for guiding the mounting unit 400 when the mounting unit 400 is slided by the sliding means 800, the guide means 900 plays the role of simultaneously holding the moving position and the angle when the mounting unit is slided so that the pinion gear unit 600 can be assembled to the rack gear portion 700 with an accurate position and an angle by the guide means 900.

As describe above, although the present invention is described with limited exemplary embodiments and the drawings, the present invention is not limited to these, and of course, various changes and alterations of the present invention can be made by a person skilled in the art without departing from the spirit and the scope of the present invention written in the claims described herein below.

1. A carriage support unit characterized in that and comprising:
a base unit provided in a way that robot and the like can be installed thereon;
a linear motion guide unit provided in the one side of the base unit, enabling linear movement of the base unit;
a mounting unit disposed in the upper surface of the base unit;
a driving means installed in the mounting unit;
a pinion gear unit coupled to the rotating shaft of the driving means;
a rack gear portion engaged with the pinion gear unit; and
a sliding means enabling the mounting unit being slided towards one direction so as to adjust the degree of engagement of the pinion gear unit with the rack gear portion;
a guide means guiding the mounting unit when the mounting unit is slided by the sliding means,
wherein the guiding means comprises: a guide slot formed in the lower surface of the mounting unit long in length towards the direction of movement of the mounting unit, and a guide pin whose one end is installed in the base unit and the other end of guide pin is inserted into the guide slot.

2. The carriage support unit according to claim 1,
wherein the sliding means comprises: a sliding block provided in the one side of the mounting unit, formed with a coupling hole formed with a first threaded portion; and a shaft whose one end is supported at the base unit, and the other end of the shaft is formed with a second threaded portion which is to be engaged with the first threaded portion.

3. The carriage support unit according to claim 1,
wherein the pinion gear unit comprises:
a first disc block;
a second disc block disposed in parallel with and spaced apart from the first disc block; and
a plurality of gear teeth whose one end is connected to the one surface of the first disc block, the other end of the plurality of gear teeth is connected to the one surface of the second disc block, formed in the shape of a cylinder, disposed spaced apart from each other along the circumference of the first disc block and the second disc block, wherein the gear teeth are engaged with the rack gear portion.

4. A robot carriage characterized in that and comprising:
a pair of frame members disposed in parallel with each other; and
a carriage support unit provided in a way that movable along the frame members, provided in a way that robot and the like can be installed thereon,
wherein the carriage support unit comprises:
a base unit disposed traversing the upper surface of the pair of frame members, provided in a way that the robot can be installed thereon;
a linear motion guide unit provided in the both sides of the base unit and in each of the pair of frame members, enabling the base unit to be moved linearly along the frame members;
a mounting unit disposed in the upper surface of the base unit;
a driving means installed in the mounting unit;
a pinion gear unit coupled to the rotating shaft of the driving means;
a rack gear portion provided in any one frame member of the pair of frame members, engaged with the pinion gear unit;
a sliding means enabling the mounting unit being slided towards one direction so as to adjust the degree of engagement of the pinion gear unit with the rack gear portion;
a guide means comprising a guide slot formed in the lower surface of the mounting unit long in length towards the direction of movement of the mounting unit for guiding the mounting unit when the mounting unit is slided by the sliding means, and a guide pin whose one end is installed in the base unit and the other end of the guide pin is inserted into the guide slot for guiding the mounting unit when the mounting unit is slided by the sliding means.
